(19) United States
(12) Patent Application Publication
(10) Pub. No.: US 2007/0113221 A1
(43) Pub. Date: May 17, 2007

(54) XML compiler that generates an application specific XML parser at runtime and consumes multiple schemas

(76) Inventors: Erxiang Liu, Austin, TX (US); Ningning Wang, Round Rock, TX (US)

Correspondence Address: IBM CORPORATION;INTELLECTUAL PROPERTY LAW, 11400 BURNET ROAD, AUSTIN, TX, 78758, US

(21) Appl. No.: 11/214,575

(22) Filed: Aug. 30, 2005

(51) Int. Cl. G06F 9/45; G06F 17/00

(52) U.S. Cl. 717/143; 715/513

(57) ABSTRACT

In accordance with the teachings of the present invention, a method is presented for generating an application-specific XML parser at runtime. Multiple XML schemas are received and used to generate a software generation tool. The software generation tool then produces an application-specific XML parser that can parse XML input files at runtime.

### CROSS-REFERENCE TO RELATED APPLICATION

This application is a continuation in part of U.S. application Ser. No. ______ filed ______ and entitled, “XML compiler that will generate and application Specific XML Parser,” which is hereby incorporated by reference in its entirety.

### BACKGROUND OF THE INVENTION

1. Field of the Invention

The present invention relates to software. Specifically, this application relates to Internet related software.

2. Description of the Prior Art

Extensible Markup Language (XML) is a widely accepted standard for describing data. XML is a standard that allows an author/programmer, etc to describe and define data (i.e., type and structure) as part of the XML content (i.e., document, etc). Since XML content may describe data, any application that understands XML regardless of the applications programming language and platform has the ability to process the XML based content.

An XML parser is a software program that checks XML syntax and processes XML data so that it is available to applications. XML content can optionally reference another document or set of rules that define the structure of an XML document/content. This other document or set of rules is often referred to as a Schema. When an XML document references a Schema, some parsers (i.e., validating parsers) can read the Schema and check that the XML document adheres to the structure defined in the Schema. If the XML document adheres to the structure defined in the Schema, then the XML document is considered valid.

XML has become the industry standard for exchanging data across systems because of its flexibility and consistent syntax. A parser processes XML content. However, conventional XML parsing (i.e., processing by a parser) is slow. Once reason for the lack of performance (i.e., slow speed) is the use of general-purpose external parsers. These parsers process XML content into general-purpose data structures and then apply run-time analysis to rebind the data to application-specific structures. Extra space is consumed by the intermediate data structures (i.e., general purpose data structures) and extra time is spent creating and analyzing them. Moreover, it is labor intensive to write the conversion code that converts the general-purpose data structures to application-specific data structures required for final processing.

There are three broad types of conventional XML parsers: SAX (Simple API for XML) parsers, DOM (Document Object Model) parsers, and data-binding parsers. Each type of XML parser defines a standard for accessing and manipulating XML documents. However, for various reasons, each of these parsers is slow and labor intensive to implement. For example, general-purpose parsers are built to accommodate all types of XML content; therefore, there is a tremendous amount of extraneous material (i.e., unnecessary code) included in a general-purpose parser that effects parser performance.

SAX (Simple API for XML) uses an event-driven model to process XML content. A SAX parser initiates a series of events as it reads an XML document from beginning to end. The events are passed to event handlers, which provide access to the content in the document. Some of these event handlers check the syntax of the XML document (i.e., syntactic events). In conventional SAX parsers, a developer has to program the event handlers (i.e., developer-written events). In addition, a SAX parser invokes developer-written callback routines to manage the syntactic events. A callback routine is a routine that is executed as part of the operation of some other routine.

There are many shortcomings to conventional SAX parsers. First, developers have to manually program the event handlers and the callback routines. In addition, conventional SAX parsers are slow for various reasons. For example, some SAX parsers scan the XML input more than once, other SAX parsers perform serial processing of the XML document, and many SAX parsers build a number of intermediate data structures to facilitate the parsing of the XML document.

At the other extreme, DOM parsers first parse an XML document to build an internal, tree-shaped representation of the XML document. The developer then uses an Application Programmer Interface (API) to access the contents of the document tree for further analysis. This is redundant since the state information that is required for analysis was available at parse time. Further, DOM parsers typically limit parallel processing by building the tree before invoking analysis code. The redundancy and limits on parallel processing result in slow parsing.

Finally, data-binding parsers work by mapping XML elements to application objects (i.e., element-specific objects). However, data-binding engines often use high-cost methods such as reflection and run-time rule evaluation.

Thus, there is a need for a method and apparatus for performing XML parsing. There is a need for a method and apparatus for performing fast, XML parsing that is cost-effective and that is not as labor intensive as conventional parsers.

### SUMMARY OF THE INVENTION

In accordance with the teachings of the present invention, a method of generating an application-specific XML parser at runtime is presented. Compiler technology is used to automatically generate a fast and small application specific parser at runtime. An XML input file is provided. Two or more specifications are provided. Each specification includes two components: (1) an XML schema that specifies syntax, data elements, and data types; and (2) semantic actions that include a pairing of an XPath string and an action code. The specifications and the XML input file are used to generate a state machine and state transition sequences that invoke the semantic actions. The state transition sequences are then used to generate the application-specific XML parser.

In accordance with the teachings of the present invention, generating an application specific parser at runtime facilitates the processing of multiple XML schema and semantic actions. In one embodiment, the multiple XML schemas are interrelated and refer to each other to construct a complete definition. For instance, a purchase order schema may include a customer schema and a product schema. In this case where there are multiple interrelated schemas, in accordance with the teachings of the present invention, the schema relationships are analyzed and parsing is performed based on the schema relationships.

The method of the present invention includes a number of advantageous characteristics, for example, the method: (1) generates smaller code which is good for use in small device; (2) uses less memory since there is no need to parse an entire tree structure; (3) saves space since there is no need to store intermediate data structures; (4) is at least twice as fast as multithreading parsers; (5) reduces runtime analysis used to rebind the data; (6) creates reusable tools based on the application specific XML schema and semantic action; (7) results in a shorter development cycle. In one embodiment of the inventive method may be used to quickly develop XML parsers that are smaller and faster in areas such as embedded systems, performance-critical applications, consulting services, etc. In a second embodiment the inventive method may be incorporated as a plug-in into an integrated development environment (IDE).

A method of generating an XML parser, comprises the steps of at runtime; receiving an XML input file; receiving a plurality of specifications each comprising an application specific XML schema and semantic action, wherein the XML input file is compliant with the XML schema and the semantic action; generating a state machine in response to the plurality of specifications; generating state transition sequences in response to the plurality of specifications and in response to the state machine; and generating an application-specific parser in response to the state transition sequences.

A computer program product comprises a computer useable medium including a computer readable program, wherein the computer readable program when executed on a computer causes the computer to: at runtime; receive an XML input file; receive a plurality of specifications each comprising an application specific XML schema and semantic action, wherein XML input file is compliant with the XML schema and the semantic action; generate a state machine based on the plurality of specifications; generate state transition sequences based on the plurality of specifications and the state machine; and generate an application-specific parser based on the state transition sequences.

A method of processing XML files, comprises the steps of at runtime; receiving two or more XML input files; receiving at two or more specifications each comprising XML schema and semantic actions, where each of the two or more XML input files is compliant with at least one of the two or more specifications; generating a software tool in response to the based on the two or more XML input files and based on the two or more specifications; and generating a parser capable of parsing the two or more XML input files.

### BRIEF DESCRIPTION OF THE DRAWINGS

FIG. 1 displays a flow diagram detailing a method implemented in accordance with the teachings of the present invention.

FIG. 2 displays a flow diagram detailing a method of implementing a state machine and the associated code implemented in accordance with the teachings of the present invention.

FIG. 3 displays a computer architecture implemented in accordance with the teachings of the present invention.

### DESCRIPTION OF THE INVENTION

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

In accordance with the teachings of the present invention, a novel method is implemented as a software generation tool, such as a compiler. In one embodiment, the software generation tool includes computer instructions implementing a method of the present invention to produce an application-specific XML parser. The software generation tool receives an XML file as input (i.e., XML input file) and generates an application-specific parser to parse the XML input file in real time (i.e., at runtime). In one embodiment, an application-specific parser is a parser that is designed to efficiently parse a specific application (i.e., XML file).

During operation, at runtime, a specification (i.e., XML schema and semantic actions) is provided. Implementing the method of the present invention, multiple, interrelated, XML schema and semantic action pairings (i.e., specifications) are provided as input to the software generation tool. In addition, the XML input file is provided as input to the software generation tool and is used in conjunction with the specifications to generate computer instructions (i.e., code, software) that will manage different states (i.e., during operation of the software generation tool a state machine is developed). The software generation tool then produces (i.e., generates) an application-specific parser that can parse the XML input file.

In summary, two inputs are provided to the software generation tool, 1) an XML input file and 2) at least one specification. The method of the present invention is implemented as a software generation tool that generates an application-specific parser. The application-specific parser is generated at runtime and is specifically tailored and designed to parse the XML input file. As a result, faster, more efficient, parsing of the XML input file is accomplished.

In one embodiment, leveraging the SAX parser methodology, the software generation tool automatically generates the callback code (i.e., subroutines that support different states of the state machine) from the specification. As mentioned previously, the specification consists of two parts. The first part of the specification is an XML schema. From the XML schema, the generation tool can determine a hierarchy of finite-state machines that can validate and parse valid sequences of XML elements at each level. The second part of the specification is semantic actions. The semantic actions consist of a set of XPath expressions paired with action statements. The semantic actions specify which parser/state combinations trigger action processing. The actions are then compiled directly into the appropriate callback routines (i.e., code). Further, by analyzing the XML schema (i.e., internal data structures, XML attributes, and XML content elements) used within each action specification, it is possible to infer data dependencies between actions. From this, the generation tool can generate a small set of intermediate data structures to facilitate quick runtime processing.

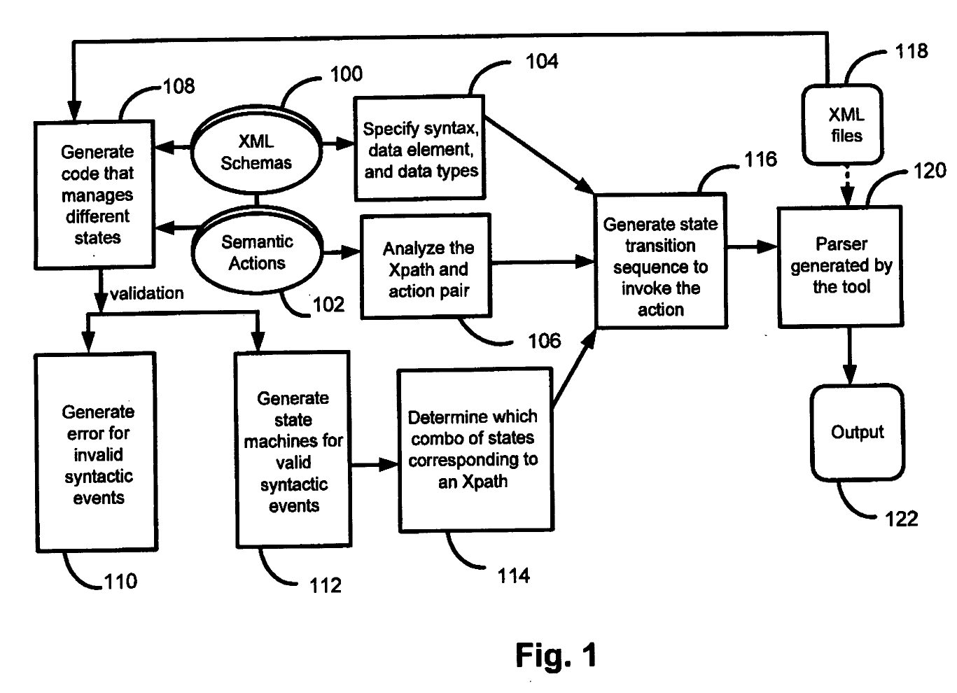

FIG. 1 displays a flow diagram implemented in accordance with the teachings of the present invention. A specification is provided. The specification consist of the XML schemas 100 and the semantic actions 102. As shown at 104, syntax, data elements and data types may be specified based on the XML schema 100. At step 102, semantic actions are provided. In one embodiment, a semantic action is an operation that is performed based on a pattern match. In other words, when a pattern is matched or criteria is satisfied a piece of software/code is executed.

XPath is a language for finding information in an XML document. For example, XPath is used to navigate through elements and attributes in an XML document. An action pair is the action that is taken in conjunction with the Xpath instructions. Specifically, the semantic actions stated in 102 are launched to analyze the Xpath and action pairs as stated at 106. At step 108, the XML schemas 100 and the semantic actions 102 are used in conjunction with the XML input file (i.e., the file that will be parsed by the parser) to generate code that handles different states (i.e., callback code or callbacks). An analysis is made of the XML file input 118 and the specification (i.e., XML schemas 100 and the semantic actions 102) and at step 108, code (i.e., callback routines) is then generated to manage each of these different states.

Two steps are then performed as part of a validation process. At step 110 errors are generated for invalid syntactic events. At step 112, a state machine is generated for valid syntactic events. It should be appreciated that invalid syntactic events (i.e., 110) and valid syntactic events (i.e., 112) are defined based on the operation of the semantic actions 102 on the XML schemas 100.

Once the state machine for valid syntactic events are generated as shown in 112, an analysis is made to determine which combination of states in the state machine correspond to an Xpath 114. At step 116, using the syntax, data elements and data types specified at 104, the analysis of the xpath and action pairs 106 and the combination of states in the state machine that correspond to an Xpath 114, a state transition sequence is generated to invoke the actions 116. The step of generating a state transition sequence to invoke the actions 116 is then used to produce an application-specific parser 120. The application-specific parser 120 may then process XML files 118 to produce an output 122.

In one embodiment, the method of the present invention is implemented in a software generation tool. The XML schemas 100 and the semantic actions 102 (i.e., the specifications) serve as inputs to the software generation tool. The steps 108, 110, 112, 104, 106, 114 and 116 are the novel method steps performed by the software generation tool. The output of the software generation tool is the application-specific parser shown as 120. The application-specific parser shown by 120 then receives XML files 118 (i.e., a specific application) and then is able to efficiently parse the XML files 118 to produce an output 122. Using the software generation tool (i.e., method of the present invention), an application-specific parser 120 is automatically generated based on a specification (i.e., XML schemas 100 and semantic actions 102). In one embodiment, automatically generating an application-specific parser 120 includes using the method of the present invention, to generate the computer instructions (i.e., the parser instructions) and peripheral computer instructions (i.e., events handlers, callback routines, etc) necessary to implement an application-specific parser. This alleviates the need for programmer development of computer instructions (i.e., code, software) such as event handlers and callback routines. In addition, an application specific parser is produced. The application-specific parser 120 performs quick and efficient parsing because the application-specific parser is specifically designed to parse the XML files 118 (i.e., the application).

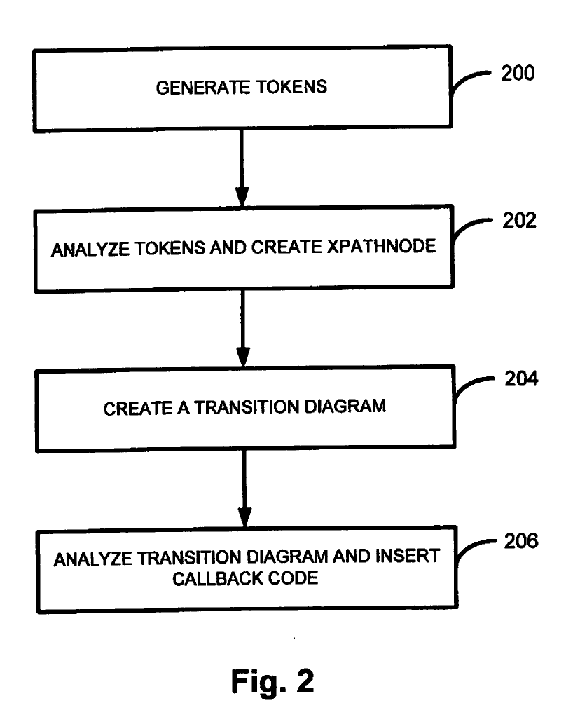

FIG. 2 displays a flow diagram detailing a state machine and the associated code implemented in accordance with the teachings of the present invention. At step 200, the application scans the XML schemas and semantic actions (i.e., FIG. 1, items 100 and 102) and generates tokens. For example, a token extraction tool such as “StringTokenizer” may be utilized to decompose a string into elementary tokens. At 202, as the application recognizes tokens, the application then analyzes the tokens and creates XPathNodes with an appropriate type element and attribute. Examples of XpathNodes are “student/university” or “student/high-school.” At step 204, the application creates a transition diagram. For example, the transition diagram may state that “state A” transitions to “state B” when it encounters a specific XPathNode. At step 206, an analysis is made of the transition diagram (i.e., traversing each node) and callback code is inserted when the XPathNode is encountered.

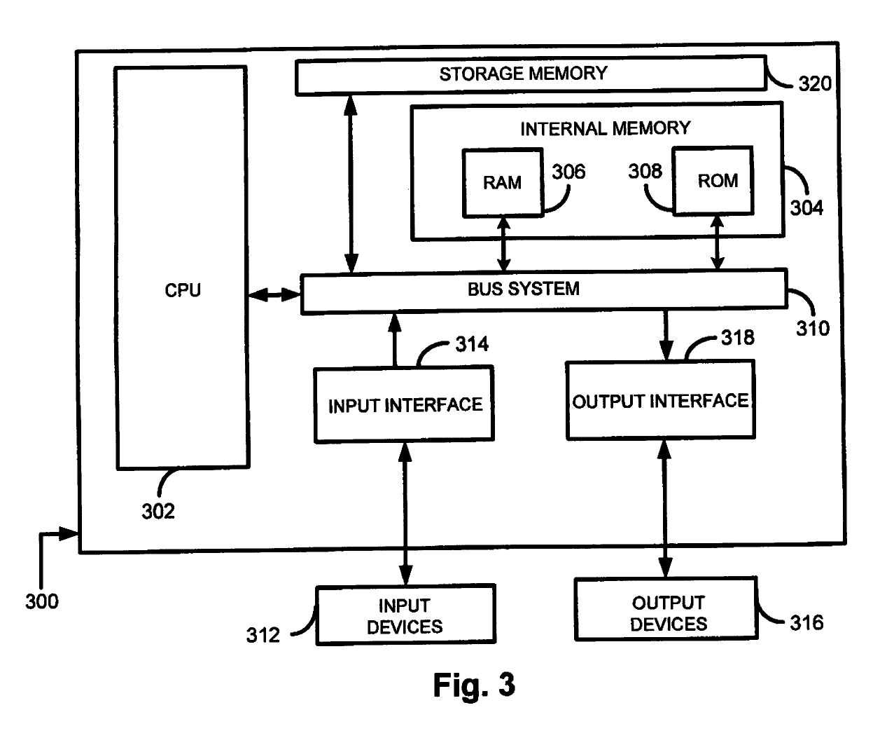

FIG. 3 displays a computer architecture capable of implementing the teachings of the present invention. The methods depicted in FIGS. 1 and 2 may be implemented with a computer architecture such as the one displayed in FIG. 3. In FIG. 3, a block diagram of a computer architecture 300 is shown. A central processing unit (CPU) 302 functions as the brain of the computer 300. Internal memory 304 is shown. The internal memory 304 includes short-term memory 306 and long-term memory 308. The short-term memory 306 may be a Random Access Memory (RAM) or a memory cache used for staging information. The long-term memory 308 may be a Read Only Memory (ROM) or an alternative form of memory used for storing information. Storage memory 320 may be any memory residing within the computer 300 other than internal memory 304. In one embodiment of the present invention, storage memory 320 is implemented with a hard drive.

In one embodiment, the methods of the present invention may be implemented in software stored in one of the foregoing memories (i.e., 306, 308, 320). In addition, CPU 302 may operate to perform the methods depicted in FIGS. 1 and 2. A bus system 310 is used to communicate information within computer 300. In addition, the bus system 310 may be connected to interfaces that communicate information out of the computer 300 or receive information into the computer 300.

Input device, such as tactile input device, joystick, keyboards, microphone, communications connections, or a mouse, are shown as 312. The input device 312 interfaces with the system through an input interface 314. Output device, such as a monitor, speakers, communications connections, etc., are shown as 316. The output device 316 communicates with computer 300 through an output interface 318.

The software generation tool implementing the teachings of the present invention may be implemented as computer instructions. The computer instructions may be stored on one of the memories (i.e., 306, 308, 304, 320). The CPU 302 may then operate under the direction of the compute instructions to implement the method of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

It is, therefore, intended by the appended claims to cover any and all such applications, modifications, and embodiments within the scope of the present invention.

What is claimed is:

1. A method of generating an XML parser, comprising the steps of:
at runtime;
receiving an XML input file;
receiving a plurality of specifications each comprising an application specific XML schema and semantic action, wherein the XML input file is compliant with the XML schema and the semantic action;
generating a state machine in response to the plurality of specifications;
generating state transition sequences in response to the plurality of specifications and in response to the state machine; and
generating an application-specific parser in response to the state transition sequences.

2. A method of generating an XML parser as set forth in claim 1, further comprising the step of generating computer instructions that manage different states in response to the plurality of specifications, and generating the state machine in response to generating the computer instructions that manage different states.

3. A method of generating an XML parser as set forth in claim 2, comprising the steps of generating errors for invalid syntactic events in response to generating computer instructions that manage different states.

4. A method of generating an XML parser as set forth in claim 1, wherein the state machine is generated for valid syntactic events.

5. A method of generating an XML parser as set forth in claim 1, wherein the step of generating state transition sequences in response to the plurality of specifications and in response to the state machine is performed in response to determining which combination of states correspond to an Xpath.

6. A method of generating an XML parser as set forth in claim 1, wherein the step of generating state transition sequences in response to the plurality of specifications and in response to the state machine is performed in response to analyzing Xpath action pairs.

7. A method of generating an XML parser as set forth in claim 1, wherein the step of generating state transition sequences in response to the plurality of specifications and in response to the state machine is performed in response to specifying syntax, data elements, and data types.

8. A computer program product comprising a computer useable medium including a computer readable program, wherein the computer readable program when executed on a computer causes the computer to:
at runtime;
receive an XML input file;
receive a plurality of specifications each comprising an application specific XML schema and semantic action, wherein XML input file is compliant with the XML schema and the semantic action;
generate a state machine based on the plurality of specifications;
generate state transition sequences based on the plurality of specifications and the state machine; and
generate an application-specific parser based on the state transition sequences.

9. A computer program product as set forth in claim 8, further causing the computer to generate computer instructions that manage different states based on the plurality of specifications, and generating the state machine based on generating computer instructions that manage the different states.

10. A computer program product as set forth in claim 9, further causing the computer to generate errors for invalid syntactic events in response to generating computer instructions that manage different states based on the plurality of specifications.

11. A computer program product as set forth in claim 8, wherein the state machine is generated for valid syntactic events.

12. A computer program product as set forth in claim 8, wherein the step of generating state transition sequences based on the plurality of specifications and the state machine is performed in response to determining which combination of states correspond to an Xpath.

13. A computer program product as set forth in claim 8, wherein the step of generating state transition sequences based on the plurality of specifications and the state machine is performed in response to analyzing Xpath action pairs.

14. A computer program product as set forth in claim 8, wherein the step of generating state transition sequences based on the plurality of specifications and the state machine is performed in response to specifying syntax, data elements, and data types.

15. A method of processing XML files, comprising the steps of:
at runtime;
receiving two or more XML input files;
receiving at two or more specifications each comprising XML schema and semantic actions, where each of the two or more XML input files is compliant with at least one of the two or more specifications;
generating a software tool in response to the based on the two or more XML input files and based on the two or more specifications; and
generating a parser capable of parsing the two or more XML input files.

16. A method of processing XML files as set forth in claim 15, further comprising the step of generating a state machine in response to the two or more specifications and generating the software tool in response to the state machine, in response to the two or more XML input files and in response to the two or more specifications.

17. A method of processing XML files as set forth in claim 16, further comprising the step of generating callback routines associated with the state machine.

18. A method of processing XML files as set forth in claim 16, further comprising the steps of identifying states in response to the two or more specifications, wherein the state machine is generated based on the states, and the method of processing the XML files further comprising the step of determining which states correspond to Xpaths.

19. A method of processing XML files as set forth in claim 16, further comprising the step of generating a state transition sequences to invoke an action in response to generating the state machine, wherein the step of generating a parser capable of parsing the two or more XML input files is performed in response to generating the state transition sequences to invoke the action.

20. A method of processing XML files as set forth in claim 15, further comprising the step of generating two or more state machines each associated with one of the two or more specifications and generating the software tool in response to the two or more state machines, in response to the two or more XML input files and in response to the two or more specifications.
